(19) United States
(12) Patent Application Publication
(10) Pub. No.: US 2018/0049130 A1
(43) Pub. Date: Feb. 15, 2018

(54) SYNCHRONIZATION FOR WAKE-UP RADIO

(71) Applicants: Po-Kai Huang, West Lafayette, IN (US); Robert J. Stacey, Portland, OR (US); Minyoung Park, Portland, OR (US)

(72) Inventors: Po-Kai Huang, West Lafayette, IN (US); Robert J. Stacey, Portland, OR (US); Minyoung Park, Portland, OR (US)

(21) Appl. No.: 15/391,620

(22) Filed: Dec. 27, 2016

Related U.S. Application Data
(60) Provisional application No. 62/374,090, filed on Aug. 12, 2016.

(51) Int. Cl. H04W 52/02

(52) U.S. Cl. CPC H04W 52/0235; H04W 52/0248; H04W 84/12

(57) ABSTRACT

An apparatus for a station (STA) is generally described herein. The STA includes a low-power WUR (LP-WUR), a local timing synchronization function (TSF) timer, and processing circuitry. The processing circuitry can decode a signal received from an access point (AP) at the LP-WUR, the signal including a TSF value, the TSF value including a subset of octets of a TSF timer associated with the AP. The STA can synchronize the local TSF timer of the STA with the TSF timer associated with the AP by adjusting a local TSF timer based on a count of a number of octets included in the subset of octets. The LP-WUR can wake up a wireless local area network (WLAN) radio of the STA at a wake-up time based on the local TSF timer. Other methods, apparatuses and systems are also described.

### PRIORITY CLAIM

This application claims the benefit of priority to U.S. Provisional Patent Application Ser. No. 62/374,090, filed Aug. 12, 2016, and entitled “SYNCHRONIZATION AND DUTY CYCLE FOR WAKE UP RADIO,” which is incorporated herein by reference in its entirety.

### TECHNICAL FIELD

Embodiments pertain to wireless networks. Some embodiments relate to wireless local area networks (WLANs) and Wi-Fi networks including networks operating in accordance with the IEEE 802.11 family of standards, such as the IEEE 802.11ac standard or the IEEE 802.11ax study group. Some embodiments relate to a low-power wake-up radio (LP-WUR). Some embodiments relate to synchronization for LP-WUR.

### BACKGROUND

In recent years, applications have been developed relating to social networking, Internet of Things (IoT), wireless docking, and the like. It may be desirable to design low power solutions that can be always-on. However, constantly providing power to a wireless local area network (WLAN) radio may be expensive in terms of battery life.

### BRIEF DESCRIPTION OF THE DRAWINGS

FIG. 1 illustrates a wireless network, in accordance with some embodiments;

FIG. 2 illustrates a station (STA) in accordance with some embodiments and an access point (AP), in accordance with some embodiments;

FIG. 3 illustrates an example system in which a low-power wake-up radio is operated, in accordance with some embodiments;

FIG. 4 illustrates clock drift between a transmitting device and a receiving device;

FIG. 5 illustrates periodic transmission of a signal including a time synchronization function (TSF) having a reduced number of bits in accordance with some embodiments;

FIG. 6 illustrates periodic wake-up of a wireless local area network (WLAN) radio of a device a by low-power wake-up radio (LP-WUR) of the device in accordance with various embodiments;

FIG. 7 illustrates wake-up of a WLAN radio by a LP-WUR after failure to receive a signal from an access point (AP) for a time period in accordance with various embodiments;

FIG. 8 illustrates periodic wake-up of a LP-WUR in accordance with various embodiments;

FIG. 9 illustrates early wake-up of a WLAN radio by a LP-WUR to account for drift in accordance with various embodiments;

FIG. 10 is a flow chart of an example method in accordance with various embodiments; and

FIG. 11 illustrates an example machine, in accordance with some embodiments.

### DETAILED DESCRIPTION

The following description and the drawings sufficiently illustrate specific embodiments to enable those skilled in the art to practice them. Other embodiments can incorporate structural, logical, electrical, process, and other changes. Portions and features of some embodiments can be included in, or substituted for, those of other embodiments. Embodiments set forth in the claims encompass all available equivalents of those claims.

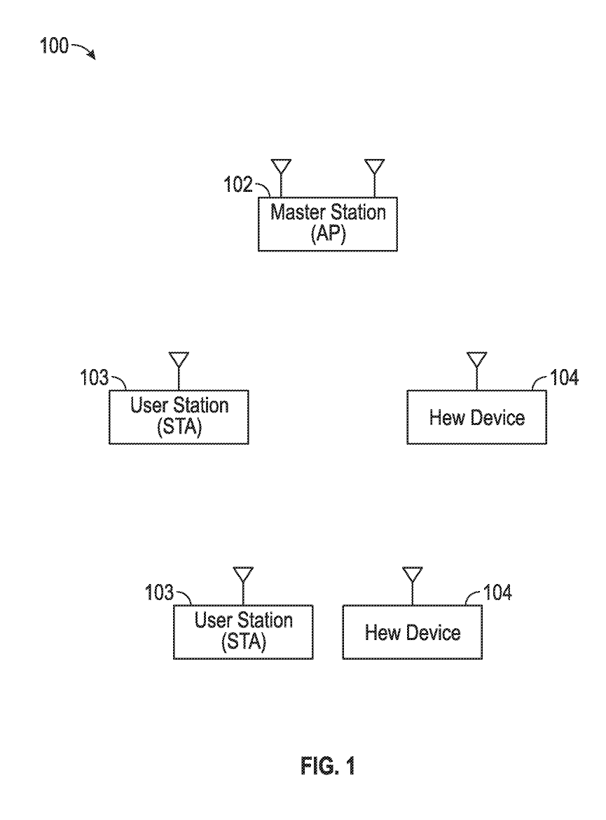

FIG. 1 illustrates a wireless network in accordance with some embodiments. In some embodiments, the network 100 can be a High Efficiency Wireless (HEW) Local Area Network (LAN) network. In some embodiments, the network 100 can be a Wireless Local Area Network (WLAN) or a Wi-Fi network. These embodiments are not limiting, however, as some embodiments of the network 100 can include a combination of such networks. That is, the network 100 may support HEW devices in some cases, non-HEW devices in some cases, and a combination of HEW devices and non-HEW devices in some cases. Accordingly, it is understood that although techniques described herein can refer to either a non-HEW device or to an HEW device, such techniques can be applicable to both non HEW devices and HEW devices in some cases.

Referring to FIG. 1, the network 100 can include any or all of the components shown, and embodiments are not limited to the number of each component shown in FIG. 1. In some embodiments, the network 100 can include a master station (AP) 102 and can include any number (including zero) of stations (STAs) 103 and/or HEW devices 104. The AP 102 can be arranged to communicate with one or more of the components shown in FIG. 1 in accordance with one or more IEEE 802.11 standards (including 802.11ax, 802.11ah and/or others), other standards and/or other communication protocols. It should be noted that embodiments are not limited to usage of an AP 102. References herein to the AP 102 are not limiting and references herein to the master station 102 are also not limiting. In some embodiments, a STA 103, HEW device 104 and/or other device can be configurable to operate as a master station. Accordingly, in such embodiments, operations that can be performed by the AP 102 as described herein can be performed by the STA 103, HEW device 104 and/or other device that is configurable to operate as the master station.

In some embodiments, one or more of the STAs 103 can be legacy stations. These embodiments are not limiting, however, as the STAs 103 can be configured to operate as HEW devices 104 or can support HEW operation in some embodiments. The master station 102 can be arranged to communicate with the STAs 103 and/or the HEW devices 104 in accordance with one or more of the IEEE 802.11 standards, including 802.11ax, 802.11ah, and/or others.

As used herein, the term “circuitry” can refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry can be implemented in, or functions associated with the circuitry can be implemented by, one or more software or firmware modules. In some embodiments, circuitry can include logic, at least partially operable in hardware. Embodiments described herein can be implemented into a system using any suitably configured hardware and/or software.

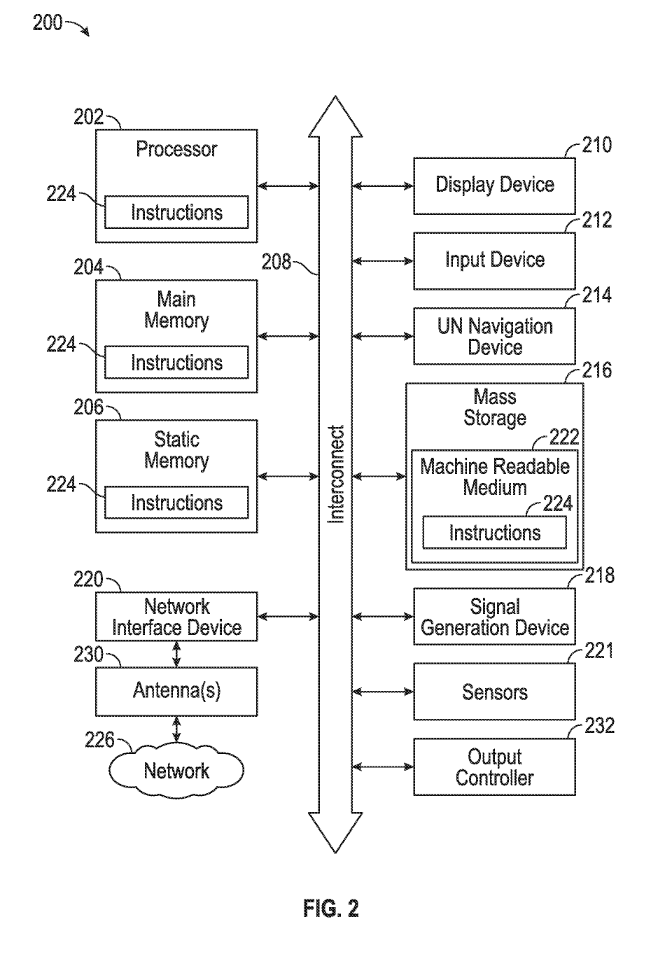

FIG. 2 illustrates a block diagram of an example machine in accordance with some embodiments. The machine 200 is an example machine upon which any one or more of the techniques and/or methodologies discussed herein can be performed. In alternative embodiments, the machine 200 can operate as a standalone device or can be connected (e.g., networked) to other machines. In a networked deployment, the machine 200 can operate in the capacity of a server machine, a client machine, or both in server-client network environments. In an example, the machine 200 can act as a peer machine in peer-to-peer (P2P) (or other distributed) network environment. The machine 200 can be an AP 102, STA 103, HEW device, HEW AP, HEW STA, UE, eNB, mobile device, base station, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples as described herein, can include, or can operate on, logic or a number of components, modules, or mechanisms. Modules are tangible entities (e.g., hardware) capable of performing specified operations and can be configured or arranged in a certain manner. In an example, circuits can be arranged (e.g., internally or with respect to external entities such as other circuits) in a specified manner as a module. In an example, the whole or part of one or more computer systems (e.g., a standalone, client or server computer system) or one or more hardware processors can be configured by firmware or software (e.g., instructions, an application portion, or an application) as a module that operates to perform specified operations. In an example, the software can reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor can be configured as respective different modules at different times. Software can accordingly configure a hardware processor, for example, to constitute a particular module at one instance of time and to constitute a different module at a different instance of time.

The machine (e.g., computer system) 200 can include a hardware processor 202 (e.g., a central processing unit (CPU), a graphics processing unit (GPU), a hardware processor core, or any combination thereof), a main memory 204 and a static memory 206, some or all of which can communicate with each other via an interlink (e.g., bus) 208. The machine 200 can further include a display unit 210, an alphanumeric input device 212 (e.g., a keyboard), and a user interface (UI) navigation device 214 (e.g., a mouse). In an example, the display unit 210, input device 212 and UI navigation device 214 can be a touch screen display. The machine 200 can additionally include a storage device (e.g., drive unit) 216, a signal generation device 218 (e.g., a speaker), a network interface device 220, and one or more sensors 221, such as a global positioning system (GPS) sensor, compass, accelerometer, or other sensor. The machine 200 can include an output controller 232, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 can include a machine-readable medium 222 on which is stored one or more sets of data structures or instructions 224 (e.g., software) embodying or utilized by any one or more of the techniques or functions described herein. The instructions 224 can also reside, completely or at least partially, within the main memory 204, within static memory 206, or within the hardware processor 202 during execution thereof by the machine 200. In an example, one or any combination of the hardware processor 202, the main memory 204, the static memory 206, or the storage device 216 can constitute machine-readable media. In some embodiments, the machine-readable medium can be or can include a non-transitory machine-readable medium. In some embodiments, the machine-readable medium can be or can include a computer-readable storage medium.

While the machine-readable medium 222 is illustrated as a single medium, the term “machine-readable medium” can include a single medium or multiple media (e.g., a centralized or distributed database, and/or associated caches and servers) configured to store the one or more instructions 224. The term “machine-readable medium” can include any medium that is capable of storing, encoding, or carrying instructions for execution by the machine 200 and that cause the machine 200 to perform any one or more of the techniques of the present disclosure, or that is capable of storing, encoding or carrying data structures used by or associated with such instructions. For example, the machine-readable medium can cause the machine 200 to decode a signal received from an access point (AP) at a low-power wake-up radio (LP-WUR) of the STA, the signal including a timing synchronization function (TSF) value, the TSF value including a subset of octets of a TSF timer associated with the AP; synchronize a local TSF timer with the TSF timer associated with the AP by adjusting a local TSF timer according to an amount of time to receive the TSF value and to pass the TSF value to medium access control layer (MAC) layer circuitry of the wireless device and further based on a count of a number of octets included in the subset of octets; and instruct the LP-WUR to wake up a wireless local area network (WLAN) radio of the STA at a wake-up time based on the local TSF timer.

Non-limiting machine readable medium examples can include solid-state memories, and optical and magnetic media. Specific examples of machine readable media can include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media can include non-transitory machine readable media. In some examples, machine readable media can include machine readable media that is not a transitory propagating signal.

The instructions 224 can further be transmitted or received over a communications network 226 using a transmission medium via the network interface device 220 utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 220 can include one or more physical jacks (e.g., Ethernet, coaxial, or phone jacks) or one or more antennas to connect to the communications network 226. In an example, the network interface device 220 can include a plurality of antennas to wirelessly communicate using at least one of single-input multiple-output (SIMO), multiple-input multiple-output (MIMO), or multiple-input single-output (MISO) techniques. In some examples, the network interface device 220 can wirelessly communicate using Multiple User MIMO techniques. The term “transmission medium” shall be taken to include any intangible medium that is capable of storing, encoding or carrying instructions for execution by the machine 200, and includes digital or analog communications signals or other intangible medium to facilitate communication of such software.

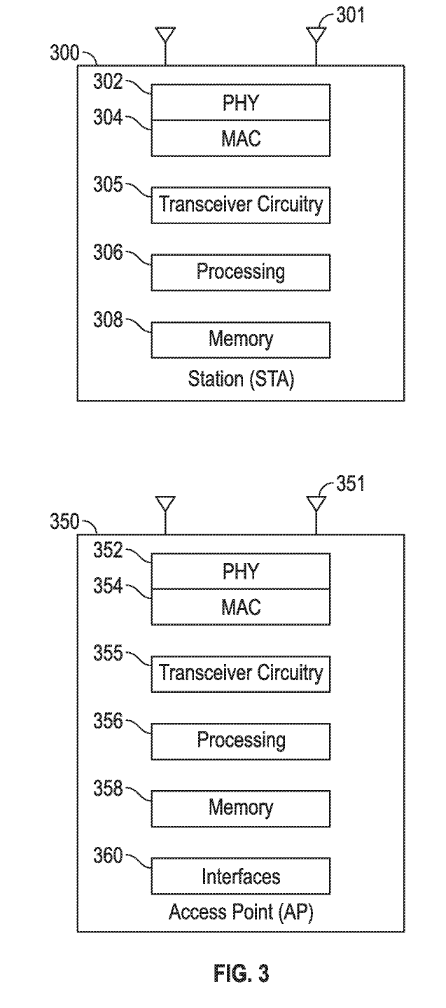

FIG. 3 illustrates a station (STA) in accordance with some embodiments and an access point (AP) in accordance with some embodiments. It should be noted that in some embodiments, an STA or other mobile device can include some or all of the components shown in either FIG. 2 or FIG. 3 (as in 300) or both. The STA 300 can be suitable for use as an STA 103 as depicted in FIG. 1, in some embodiments. It should also be noted that in some embodiments, an AP or other base station can include some or all of the components shown in either FIG. 2 or FIG. 3 (as in 350) or both. The AP 350 can be suitable for use as an AP 102 as depicted in FIG. 1, in some embodiments.

The STA 300 can include physical layer circuitry (PHY) 302 and a transceiver 305, one or both of which can enable transmission and reception of signals to and from components such as the AP 102 (FIG. 1), other STAs or other devices using one or more antennas 301. As an example, the physical layer circuitry 302 can perform various encoding and decoding functions that can include formation of baseband signals for transmission and decoding of received signals. As another example, the transceiver 305 can perform various transmission and reception functions such as conversion of signals between a baseband range and a Radio Frequency (RF) range. Accordingly, the PHY 302 and the transceiver 305 can be separate components or can be part of a combined component. In addition, some of the described functionality related to transmission and reception of signals can be performed by a combination that can include one, any or all of the PHY 302, the transceiver 305, and other components or layers. The STA 300 can also include medium access control layer circuitry (MAC) 304 for controlling access to the wireless medium. The STA 300 can also include processing circuitry 306 and memory 308 arranged to perform the operations described herein.

The AP 350 can include physical layer circuitry 352 and a transceiver 355, one or both of which can enable transmission and reception of signals to and from components such as the STA 103 (FIG. 1), other APs or other devices using one or more antennas 351. As an example, the physical layer circuitry 352 can perform various encoding and decoding functions that can include formation of baseband signals for transmission and decoding of received signals. As another example, the transceiver 355 can perform various transmission and reception functions such as conversion of signals between a baseband range and a Radio Frequency (RF) range. Accordingly, the physical layer circuitry 352 and the transceiver 355 can be separate components or can be part of a combined component. In addition, some of the described functionality related to transmission and reception of signals can be performed by a combination that can include one, any or all of the physical layer circuitry 352, the transceiver 355, and other components or layers. The AP 350 can also include medium access control layer (MAC) circuitry 354 for controlling access to the wireless medium. The AP 350 can also include processing circuitry 356 and memory 358 arranged to perform the operations described herein.

The antennas 301, 351, 230 can comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas 301, 351, 230 can be effectively separated to take advantage of spatial diversity and the different channel characteristics that can result.

In some embodiments, the STA 300 can be configured as an HEW device 104 (FIG. 1), and can communicate using OFDM and/or OFDMA communication signals over a multicarrier communication channel. In some embodiments, the AP 350 can be configured to communicate using OFDM and/or OFDMA communication signals over a multicarrier communication channel. In some embodiments, the HEW device 104 can be configured to communicate using OFDM communication signals over a multicarrier communication channel. Accordingly, in some cases, the STA 300, AP 350 and/or HEW device 104 can be configured to receive signals in accordance with specific communication standards, such as the institute of Electrical and Electronics Engineers (IEEE) standards including IEEE 802.11-2012, 802.11n-2009 and/or 802.11ac-2013 standards and/or proposed specifications for WLANs including proposed HEW standards, although the scope of the embodiments is not limited in this respect as they can also be suitable to transmit and/or receive communications in accordance with other techniques and standards. In some other embodiments, the AP 350, HEW device 104 and/or the STA 300 configured as an HEW device 104 can be configured to receive signals that were transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect. Embodiments disclosed herein provide two preamble formats for High Efficiency (HE) Wireless LAN standards specification that is under development in the IEEE Task Group 11ax (TGax).

In some embodiments, the STA 300 and/or AP 350 can be a mobile device and can be a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a wearable device such as a medical device (e.g., a heart rate monitor, a blood pressure monitor, etc.), or other device that can receive and/or transmit information wirelessly. In some embodiments, the STA 300 and/or AP 350 can be configured to operate in accordance with 802.11 standards, although the scope of the embodiments is not limited in this respect. Mobile devices or other devices in some embodiments can be configured to operate according to other protocols or standards, including other IEEE standards, Third Generation Partnership Project (3GPP) standards or other standards. In some embodiments, the STA 300 and/or AP 350 can include one or more of a keyboard, a display, a non-volatile memory port, multiple antennas, a graphics processor, an application processor, speakers, and other mobile device elements. The display can be an LCD screen including a touch screen.

Although the STA 300 and the AP 350 are each illustrated as having several separate functional elements, one or more of the functional elements can be combined and can be implemented by combinations of software-configured elements, such as processing elements including digital signal processors (DSPs), and/or other hardware elements. For example, some elements can comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements can refer to one or more processes operating on one or more processing elements.

Embodiments can be implemented in one or a combination of hardware, firmware and software. Embodiments can also be implemented as instructions stored on a computer-readable storage device, which can be read and executed by at least one processor to perform the operations described herein. A computer-readable storage device can include any non-transitory mechanism for storing information in a form readable by a machine (e.g., a computer). For example, a computer-readable storage device can include read-only memory (ROM), random-access memory (RAM), magnetic disk storage media, optical storage media, flash-memory devices, and other storage devices and media. Some embodiments can include one or more processors and can be configured with instructions stored on a computer-readable storage device.

It should be noted that in some embodiments, an apparatus used by the STA 300 can include various components of the STA 300 as shown in FIG. 3 and/or the example machine 200 as shown in FIG. 2. Accordingly, techniques and operations described herein that refer to the STA 300 (or 103) can be applicable to an apparatus for an STA, in some embodiments. It should also be noted that in some embodiments, an apparatus used by the AP 350 can include various components of the AP 350 as shown in FIG. 3 and/or the example machine 200 as shown in FIG. 2. Accordingly, techniques and operations described herein that refer to the AP 350 (or 102) can be applicable to an apparatus for an AP, in some embodiments. In addition, an apparatus for a mobile device and/or base station can include one or more components shown in FIGS. 2-3, in some embodiments. Accordingly, techniques and operations described herein that refer to a mobile device and/or base station can be applicable to an apparatus for a mobile device and/or base station, in some embodiments.

In recent years, applications have been developed relating to social networking, Internet of Things (IoT), wireless docking, and the like. It can be desirable to design low power solutions that can be always-on. Multiple efforts are ongoing in the wireless industry to address this challenge. In Bluetooth® Special Interest Group (SIG), Bluetooth® Low Energy provides a power-efficient protocol for some use cases. In the Institute of Electrical and Electronics Engineers (IEEE), low-power wake-up radio (LP-WUR) has gained a lot of interest. The idea of the LP-WUR is to utilize an extremely low power radio such that a device can be in listening mode with minimum capability and consume extremely low power. If the main radio is required for data transmission, a wake-up packet can be sent out by a peer device to wake up the main wireless local area network (WLAN) radio (e.g., Wi-Fi radio).

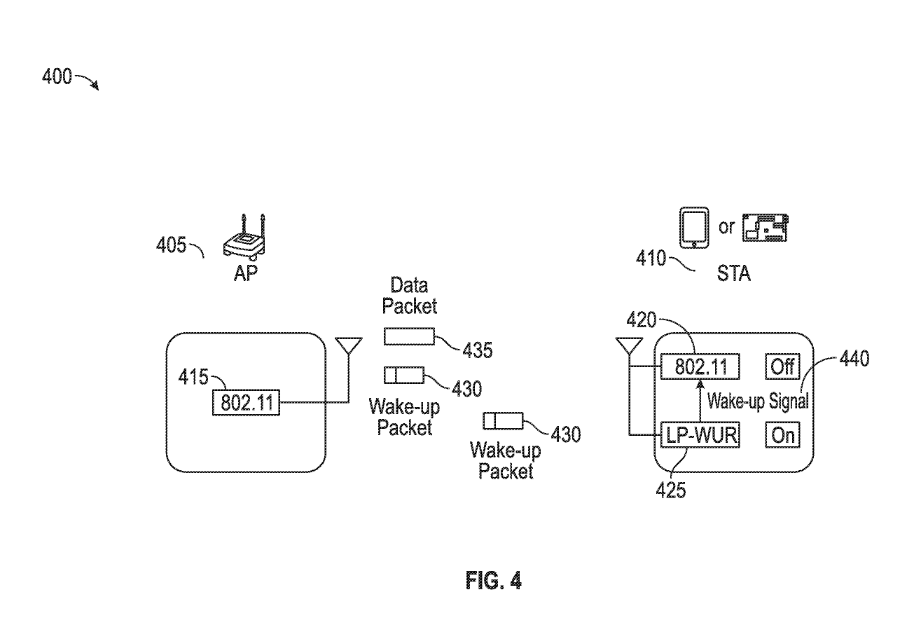

FIG. 4 illustrates an example system 400 in which a low-power wake-up radio is operated. As shown, the system 400 includes an AP 405 and a STA 410. The AP 405 can be a WLAN station (e.g., Wi-Fi router), AP 102 (FIG. 1), AP 350 (FIG. 3), or other device capable of wireless communication, such as a STA. The STA 410 can be a computing device capable of connecting to the WLAN station, such as a mobile phone, a tablet computer, a laptop computer, a desktop computer, STA 300 (FIG. 3), STA 103 (FIG. 1) and the like. The AP 405 includes a WLAN (802.11+) radio 415. The STA 410 includes a WLAN (802.11) radio 420 (e.g., Wi-Fi radio) and a LP-WUR 425. The WLAN radio 415 of the AP 405 can transmit one or more wake-up packets 430. One of the wake-up packets 430 can be received at the LP-WUR 425 of the STA 410. Upon receiving the wake-up packet 430, the LP-WUR 425 can send a wake-up signal 440, which causes the WLAN radio 420 of the STA 410 to turn on. The WLAN radio 415 of the AP 405 can transmit data packet(s) 435 to the WLAN radio 420 of the STA 410, and the WLAN radio 420 of the STA 410 receives the data packet(s) 435.

Timing synchronization is useful for legacy power save STAs because legacy power save STAs awaken periodically at a target beacon transmission time (TBTT) to receive beacons. Accurate synchronization can help the STA to awaken at the right time and avoid missing beacons. Synchronization can be provided through use of a time synchronization function (TSF). TSFs are specified in IEEE 802.11 wireless local area network (WLAN) standards to fulfill timing synchronization among users. A TSF keeps the timers for stations in the same Basic Service Set (BSS) synchronized, and all STAs, APs, etc. in a BSS are to maintain a local TSF timer. In current implementations of IEEE 802.11, each mobile host can maintain a TSF timer with modulus 2⁶⁴ counting in increments of microseconds. The TSF is based on a 1-MHz clock and “ticks” in microseconds.

Timing synchronization can be achieved by stations periodically exchanging timing information through beacon frames. STAs can adopt a received timing if the received timing is different from a STA's local TSF timer. STAs can also adopt a value that defines the length of beacon intervals or periods. This value, established by an AP or by the STA that initiates an independent BSS (IBSS), defines a series of TBTTs that are a beacon period apart.

As mentioned, currently, TSFs can include 8 octets, or 64 bits. However, reduced (e.g., partial) TSFs, included in signaling in accordance with various embodiments, include fewer than 8 octets to reduce signaling overhead. Hereinafter, this signaling including partial TSFs shall be referred to as a “mini-beacon” although some versions of IEEE 802.11 can refer to this signaling by another term, e.g., “short beacon,” reduced beacon,” etc. Embodiments are not to be understood to be limited to any particular term for signaling that includes partial TSFs. Partial TSFs provided in mini-beacons can minimize clock drift between an AP and STAs within a BSS, thereby improving synchronization so that STAs are awake at the correct time and so that STAs do not miss any beacon signals.

According to embodiments described herein, a device (e.g., a STA 103 (FIG. 1) or STA 410 (FIG. 4) enters a WUR mode after negotiating with another device (e.g., AP 102 (FIG. 1) or AP 405 (FIG. 4). The AP 405 will transmit a wake-up packet (e.g., wake-up packet 430 (FIG. 4)) to wake up the main radio of the STA (e.g., the WLAN radio 420 (FIG. 4)).

Embodiments provide that a partial TSF function is included in the mini-beacon transmitted periodically by the AP 405 and received at the LP-WUR 425 of the STA 410. The partial TSF function can comprise the x least significant octets of the AP 405 TSF timer, where x is either 1, 2, 3, or 4. For example, in some embodiments, the partial TSF can comprise the two least significant octets of the TSF timer associated with the AP 405, or in some embodiments the partial TSF can comprise the three least significant octets of the TSF timer associated with the AP 405. Note that a STA 410 receiving x least significant octets can tolerate maximum drift equal to +−2̂(x*8−1) microseconds and correct the local TSF timer when receiving a mini-beacon. In other words, if x=1, the STA 410 can tolerate a maximum drift equal to 128 microseconds. Assuming that the maximum drift between the AP 405 and STA 410 is 200 microseconds per second, if x=1, then the STA 410 can tolerate 0.64 (or 128/200) seconds without receiving a mini-beacon from the AP 405 before synchronization issues will result such that the STA 410 cannot correctly adjust the local timer based on the mini-beacon sent by the AP 405 in a later time. Similarly, if x=2, the STA 410 can tolerate 163.84 seconds (or about 2.7 minutes) with no mini-beacon and correct the local TSF timer when receiving a mini-beacon. If x=3, the STA 410 can tolerate up to 41943.04 seconds 9 (or about 11.6 hours) with no mini-beacon, and if x=4, the STA. 410 can tolerate 10737418.24 seconds with no mini-beacon.

In some situations, maximum drift between an AP 405 and STA 410 can be multiple times higher, for example three times higher or more, and therefore the amount of time that the STA 410 can tolerate without receiving a mini-beacon will be correspondingly shorter. The situation can occur in a STA 410 having a clock with lower cost and more drift, which leads to higher maximum drift between AP 405 and STA 410.

When the STA 410 receives the TSF from mini-beacon, processing circuitry 306 of the STA 410 can synchronize the local TSF timer of the STA 410. First, processing circuitry (e.g., processing circuitry 306 (FIG. 3)) will adjust the received TSF by adding an amount equal to the STA 410 delay through local PHY components (e.g., PHY 302 (FIG. 3) to MAC layer circuitry (e.g., MAC 304 (FIG. 3) plus the time since the first bit of the TSF received at the MAC/PHY interface (e.g., interface between PHY 302 and MAC 304 (FIG. 3)).

If the most significant bit (MSB) of the adjusted value of the received. TSF timer is not equal to the MSB of the x least significant octets of the local TSF timer then the processing circuitry 306 will adjust the value of the (8−x) most significant octets of the TSF timer to account for roll over as follows. The value shall be increased by one unit (modulo 2̂((8−x)*8)) if LT>AT and LT>AT+2̂(x*8−1), where AT is the adjusted value of the received Timestamp and LT is the value of the x least significant octets of the local TSF timer. The value shall be decreased by one unit (modulo 2̂((8−x)*8)) if LT<AT and LT<AT−2̂(x*8−1). Finally, the processing circuitry 306 will set the x least significant octets of the STA 410 local TSF to the adjusted value of the received TSF timer.

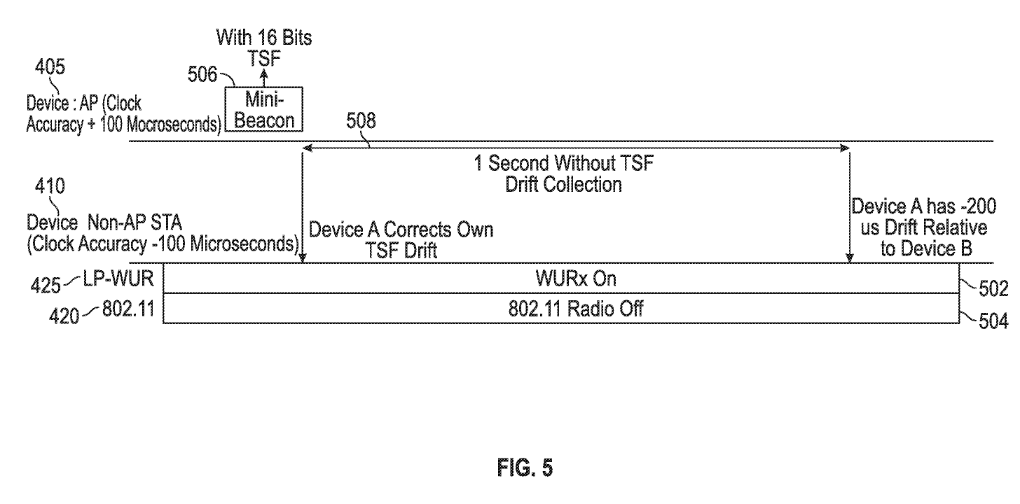

FIG. 5 illustrates clock drift between a transmitting device (e.g., the AP 405 (FIG. 4) AP 102 (FIG. 1) or AP 350 (FIG. 3)) and a receiving device (e.g., the STA 410 (FIG. 4), STA 103 (FIG. 1) or STA 300 (FIG. 3)). The on/off status of LP-WUR 425 is shown at 502, and the on/off status of the WLAN radio 420 is shown at 504. Upon the AP 405 transmitting a mini-beacon 506, the STA 410 can correct TSF drift according to algorithms described earlier herein using a partial TSF included in the mini-beacon. After one second without reception of a mini-beacon, the STA 410 will have a clock drift (for example a plus or minus 200 microsecond drift assuming parameters for maximum drift described earlier herein) relative to the AP 405. This is because, having received no mini-beacon, the STA 410 has been unable to perform synchronization or adjustment using a partial TSF according to algorithms described above.

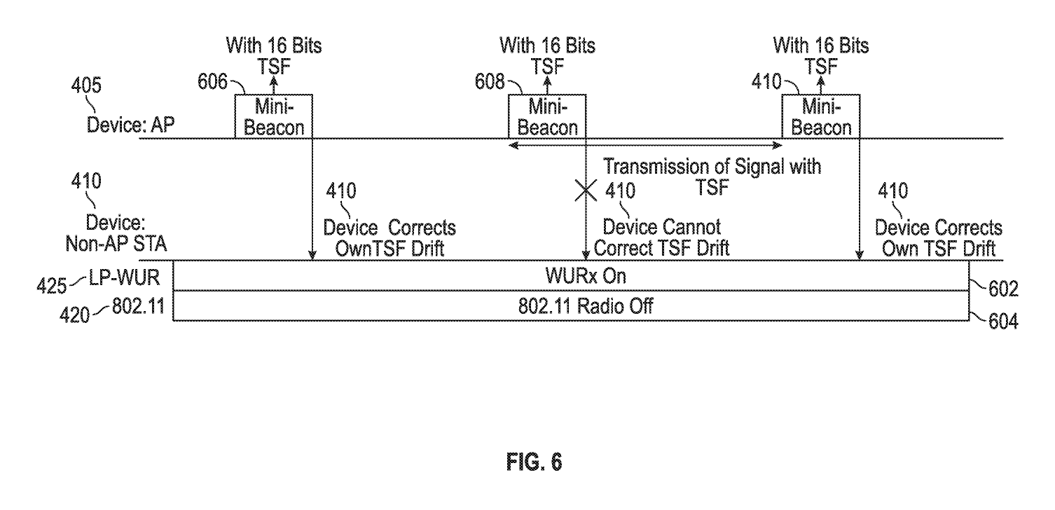

For purposes of comparison, FIG. 6 illustrates periodic transmission of a signal including a time synchronization function (TSF) having a reduced number of bits in accordance with some embodiments. The on/off status of LP-WUR 425 is shown at 602, and the on/off status of the WLAN radio 420 is shown at 604. Upon the AP 405 transmitting a mini-beacon 606, the STA 410 can correct TSF drift according to algorithms described earlier herein using a partial TSF included in the mini-beacon. If the AP 405 transmits a second mini-beacon 608, but the STA 410 was unable to receive the mini-beacon 608, then the STA 410 is unable to perform synchronization or adjustment using a partial TSF according to algorithms described above. Because the AP 405 can periodically transmit mini-beacons (similar to other 802.11 beacons), another mini-beacon 610 will be transmitted within a period for target mini-beacon transmission time (TMBTT). Assuming the mini-beacon 610 was received by the STA 410, the STA 410 can perform synchronization or adjustment using a partial TSF within the mini-beacon 610, according to algorithms described earlier herein.

As was mentioned earlier, depending on the number of octets of TSF provided in a mini-beacon, a STA 410 can tolerate different amounts of time with no mini-beacon, before synchronization issues are noticeable and performance declines. For example, if two octets of TSF are provided in a mini-beacon, the STA 410 can tolerate 163.84 seconds with no mini-beacon. Embodiments provide further safeguards in the event that mini-beacons are not received for long periods of time. For example, a LP-WUR 425 can periodically wake up the WLAN radio 420. In some embodiments, the periodicity of this periodic wake-up can be smaller than the duration that the STA 410 can tolerate failure to receive mini-beacons. In some embodiments, the period can be a multiple of the beacon interval (e.g., the time between two TBTT) so that the WLAN radio 420 is woken up in time to receive at least some beacons from the AP 405 for synchronization. In some embodiments, the periodicity of periodic wake-up can be set by agreement between the AP 405 and the STA 410. In embodiments, processing circuitry 306 is configured to encode a signal for transmission to the AP 405 to notify the AP 405 that the LP-WUR has woken up the WLAN radio.

Operations of the AP (e.g., the AP 405) therefore can include encoding a signal for transmission to a STA (e.g., the STA 410) within a BSS served by the AP. As described earlier herein, the signal can include a TSF value. The TSF value can be a partial TSF in that the TSF can include a subset of octets of a TSF timer associated with the AP (e.g., the AP 102, 350 or 405). In embodiments, the subset can include fewer than four octets. For example, the subset can include the three least-significant octets the TSF timer associated with the AP, or the subset can include the two least-significant octets of the TSF timer associated with the AP. The AP (or processing circuitry 356 of the AP) can encode a wake-up packet for transmission to the STA subsequent to transmission of the signal. Subsequent to the wake-up packet being transmitted, the AP can decode an acknowledgment from the STA indicating that a LP-WUR of the STA (e.g., LP-WUR 425) has woken a WLAN radio of the STA.

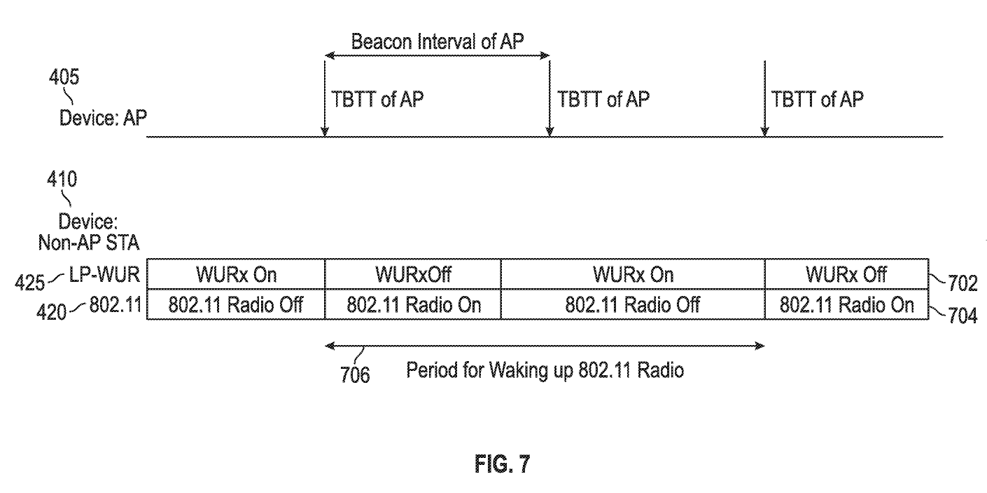

FIG. 7 illustrates periodic wake-up of a wireless local area network (WLAN) radio of a device a by low-power wake-up radio (LP-WUR) of the device in accordance with various embodiments. The on/off status of LP-WUR 425 is shown at 702, and the on/off status of the WLAN radio 420 is shown at 704. The period at which the WLAN radio 420 is woken is shown at 706. As can be appreciated, the period 706 equals a multiple (e.g., twice) of the beacon intervals, i.e., time between two TBTTs, and the WLAN radio 420 is woken at the start of a TBTT.

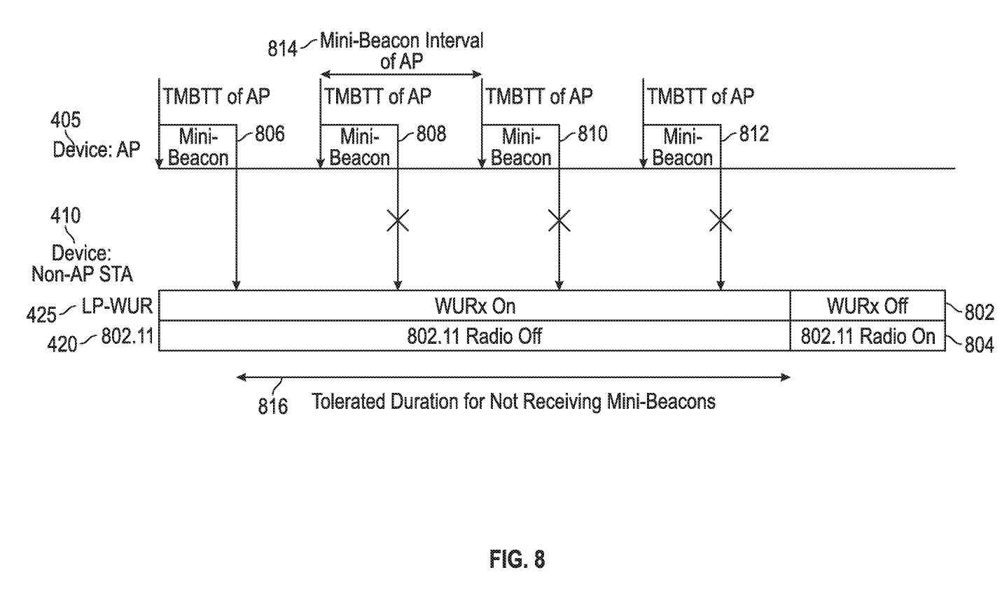

FIG. 8 illustrates wake-up of a WLAN radio by a LP-WUR after failure to receive a signal from an access point (AP) for a time period in accordance with various embodiments. The on/off status of LP-WUR 425 is shown at 802, and the on/off status of the WLAN radio 420 is shown at 804. In the example, the STA 410 receives mini-beacon 806, but is then unable to receive mini-beacons 808, 810 and 812, which are transmitted at TMBTT 814. The STA 410 is able to tolerate non-reception of mini-beacons for time 816. After time 816, the LP-WUR 425, therefore, will wake up the WLAN radio 420.

In some embodiments, the LP-WUR 425 can wake up periodically to further save power. In some embodiments, the wake-up period of the LP-WUR 425 can be smaller than the tolerated duration without receiving mini-beacon. In some embodiments, the wake-up period of the LP-WUR 425 can be a multiple of mini-beacon interval. In some embodiments, this multiplier can be smaller than 1 to have more frequent wake up and reduce the possible latency for the STA 410 to receive data from the AP 405. The LP-WUR 425 can also be set to wake up at the TMBTT so that the LP-WUR 425 can receive mini-beacons in order to obtain partial TSFs or any other information for synchronization. In some embodiments, the periodicity for waking up the LP-WUR 425 can be agreed upon in advance between the AP 405 and the STA 410, either one time, or in specification, or upon the STA 410 entering WUR mode.

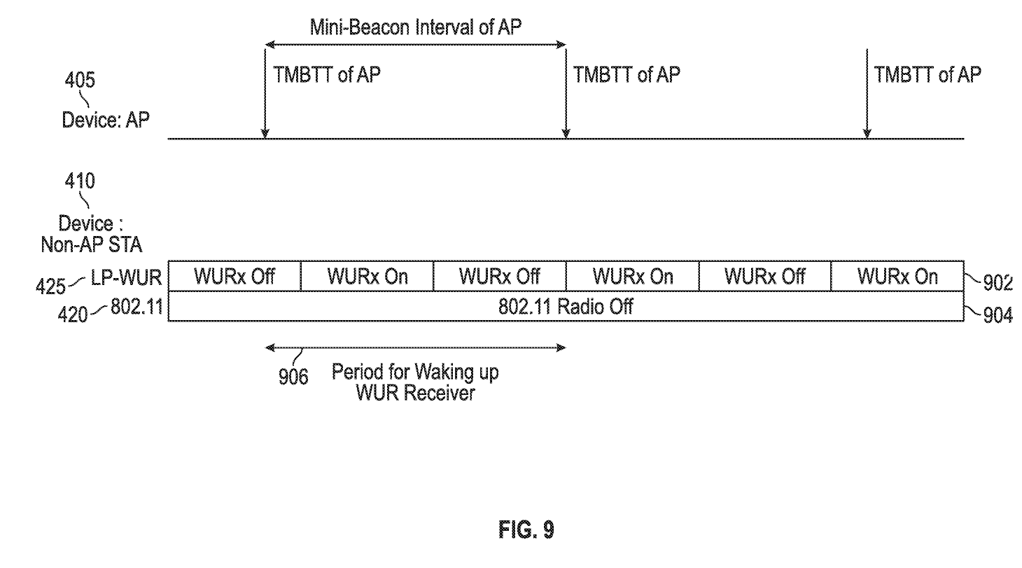

FIG. 9 illustrates periodic wake-up of a LP-WUR 425 in accordance with various embodiments. The on/off status of LP-WUR 425 is shown at 902, and the on/off status of the WLAN radio 420 is shown at 904. In the example, the LP-WUR 425 is woken periodically with periodicity 906.

To address the possible timing drift when stations wake up, embodiments provide that the STA 410 can wake either or both of the LP-WUR 425 or the WLAN radio 420 earlier than the TBTT or TMBTT to avoid missing packets or mini-beacons or beacons from the AP 405. The specific earlier awake time will depend on the calculation of timing drift, which is equal to the duration of time in seconds since last synchronization multiplied by TSF accuracy in microseconds. According to some versions of the IEEE 802.11 standards, TSF accuracy can be computed as plus or minus 200 microseconds. Given a TMBTT of 500 ms (and therefore a time since last synchronization of 500 milliseconds) then the early awake time is about 100 microseconds (i.e., 0.5 multiplied by 200 microseconds). As another example, in some embodiments and in some versions of IEEE 802.11 specifications, TSF accuracy can be computed as plus or minus 600 microseconds and TMBTT is 500 milliseconds, and therefore the early awake time is about 300 microseconds (0.5 multiplied by 600). However, it will be appreciated that these are only examples of early wake-up times. Also, other calculations or criteria can be sued to calculate early wake-up times, and embodiments are not limited to the particular algorithms or criteria described above.

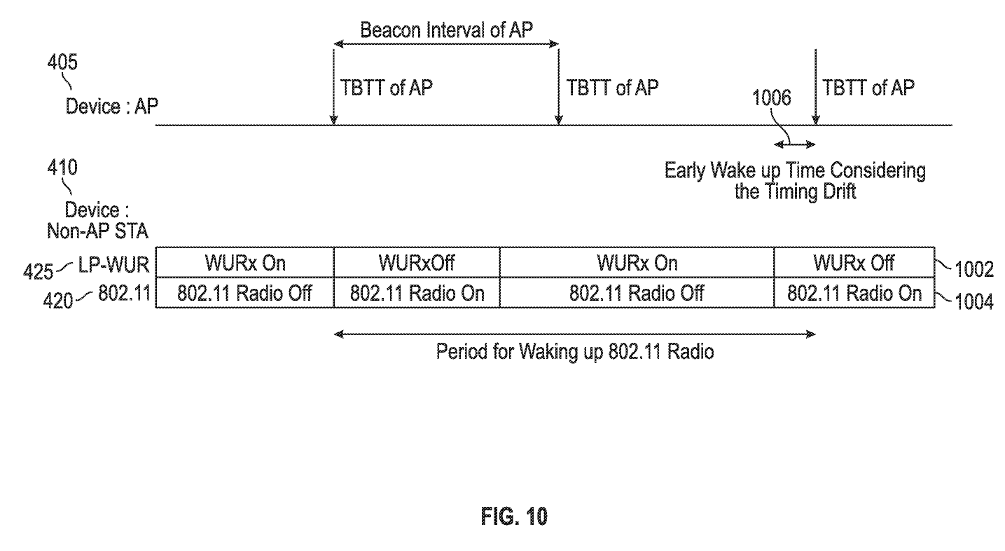

FIG. 10 illustrates early wake-up of a WLAN radio by a LP-WUR to account for drift in accordance with various embodiments. The on/off status of LP-WUR 425 is shown at 1002, and the on/off status of the WLAN radio 420 is shown at 1004. The WLAN radio 420 is woken early, by a time of 1006, before a TBTT.

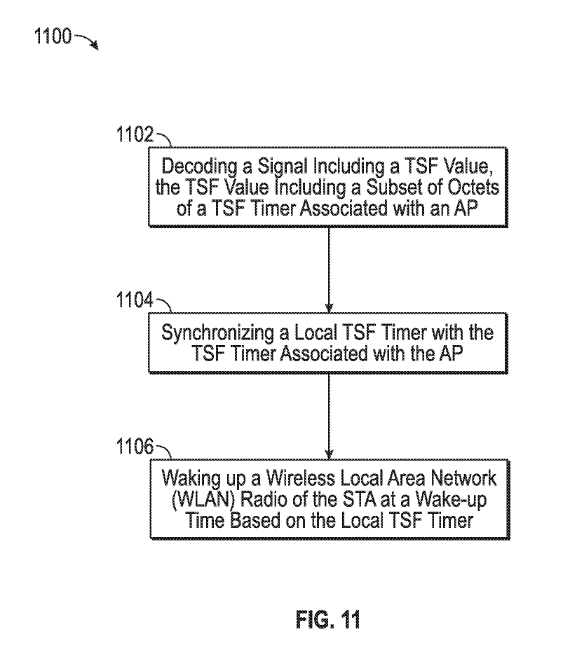

FIG. 11 is a flow chart of an example method 1100 in accordance with various embodiments. Operations of method 1100 can be performed by a STA 103 or 300, a STA 410, or a component thereof (e.g., LP-WUR 425, processing circuitry 306, or 802.11 radio 420).

The example method begins at operation 1102 with the processing circuitry 306 decoding a signal received from an AP (e.g., AP 102, AP 350, or AP 405). The signal can be received at a LP-WUR 425. The signal can include a TSF value. The TSF value can include a subset of octets of a TSF timer associated with the AP. In embodiments, the TSF value comprises two least significant octets of the TSF timer associated with the AP. In embodiments, the TSF value comprises three least significant octets of the TSF timer associated with the AP.

The example method 1100 continues with operation 1104 with the processing circuitry 306 synchronizing a local TSF timer with the TSF timer associated with the AP by adjusting a local TSF timer according to an amount of time to receive the TSF value and to pass the TSF value to MAC layer circuitry (e.g., MAC 304 (FIG. 3)) of the STA and further based on a count of a number of octets included in the subset of octets. The synchronizing can be performed according to algorithms described earlier herein. For example, when the STA 410 receives a TSF value (e.g., a partial TSF within a mini-beacon as described earlier herein), processing circuitry 306 can adjust the received TSF by adding an amount equal to the STA 410 delay through local PHY components (e.g., PHY 302 (FIG. 3) to MAC layer circuitry (e.g., MAC 304 (FIG. 3) plus the time since the first bit of the TSF received at the MAC/PHY interface (e.g., interface between PHY 302 and MAC 304 (FIG. 3)).

If the most significant bit (MSB) of the adjusted value of the received TSF timer is not equal to the MSB of the x least significant octets of the local TSF timer then the processing circuitry 306 will adjust the value of the (8−x) most significant octets of the TSF timer to account for roll over as follows. The value shall be increased by one unit (modulo 2̂((8−x)*8)) if LT>AT and LT>AT+2̂(x*8−1), where AT is the adjusted value of the received Timestamp and LT is the value of the x least significant octets of the local TSF timer. The value shall be decreased by one unit (modulo 2̂((8−x)*8)) if LT<AT and LT<AT−2̂(x*8−1). Finally, the processing circuitry 306 will set the x least significant octets of the STA 410 local TSF to the adjusted value of the received TSF timer.

The example method 1100 continues with operation 1106 with waking up a wireless local area network (WLAN) radio of the STA at a wake-up time based on the local TSF timer. Operation 1106 can be performed by a LP-WUR 425. In embodiments, the waking up is performed periodically according to a periodicity based on the count of the number of octets included in the subset of octets of the TSF timer. In embodiments, the waking up is performed periodically according to a periodicity that has been set according to an agreement with the AP. In embodiments, the waking up is performed periodically based on a target beacon transmission time (TBTT) of the AP. In embodiments, the waking up is performed responsive to a failure to receive communications from the AP within a time period.

In Example 1, an apparatus of a station (STA) can comprise: a low-power wake-up radio (LP-WUR); and processing circuitry to: decode a signal received from an access point (AP) at the LP-WUR, the signal including a timing synchronization function (TSF) value, the TSF value including a subset of octets of a TSF timer associated with the AP; and synchronize a local TSF timer with the TSF timer by adjusting the local TSF timer according to an amount of time to receive the TSF value and to pass the TSF value to medium access control layer (MAC) layer circuitry of the STA and further based on a count of a number of octets included in the subset of octets, wherein the LP-WUR is configured to wake up a wireless local area network (WLAN) radio of the STA at a wake-up time based on the local TSF timer.

In Example 2, the subject matter of Example 1 can optionally include wherein the TSF value comprises two least significant octets of the TSF timer associated with the AP.

In Example 3, the subject matter of example 1 can optionally include wherein the TSF value comprises three least significant octets of the TSF timer associated with the AP.

In Example 4, the subject matter of any of Examples 1-3 can optionally include wherein the LP-WUR is configured to wake up the WLAN radio periodically.

In Example 5, the subject matter of Example 4 can optionally include wherein the LP-WUR is configured to wake up the WLAN radio periodically according to a periodicity based on the count of the number of octets included in the subset of octets of the TSF timer.

In Example 6, the subject matter of Example 4 can optionally include wherein the LP-WUR is configured to wake up the WLAN radio periodically according to a periodicity that has been set according to an agreement with the AP.

In Example 7, the subject matter of Example 4 can optionally include wherein the LP-WUR is configured to wake up the WLAN radio periodically based on a target beacon transmission time (TBTT) of the AP.

In Example 8, the subject matter of any of Examples 1-7 can optionally include wherein the LP-WUR is configured to wake up the WLAN radio responsive to a failure to receive the signal including the TSF value within a time period.

In Example 9, the subject matter of any of Examples 1-8 can optionally include wherein the LP-WUR is configured to wake up the WLAN radio responsive to a failure to receive communications from the AP within a time period.

In Example 10, the subject matter of any of Examples 1-9 can optionally include wherein the processing circuitry is configured to encode a signal for transmission to the AP to notify the AP that the LP-WUR has woken up the WLAN radio.

In Example 11, the subject matter of any of Examples 1-10 can optionally include wherein the processing circuitry is configured to wake up the LP-WUR periodically.

In Example 12, an apparatus of an access point (AP) can include processing circuitry to: encode a signal for transmission to a station (STA) within a basic service set (BSS) served by the AP, the signal including a timing synchronization function (TSF) value, the TSF value including a subset of octets of a TSF timer associated with the AP, the subset including fewer than four octets; encode a wake-up packet for transmission to the STA subsequent to transmission of the signal; and decode an acknowledgment from the STA, subsequent to transmission of the wake-up packet, that a low-power wake-up radio (LP-WUR) of the STA has woken a wireless local area network (WLAN) radio of the STA.

In Example 13, the subject matter of Example 12 can optionally include wherein the TSF value includes a two least-significant octets of the TSF timer associated with the AP.

In Example 14, the subject matter of Example 12 can optionally include wherein the TSF value includes a three least-significant octets of the TSF timer associated with the AP.

In Example 15, a non-transitory computer-readable storage medium may store instructions for execution by processing circuitry to perform operations for communication by a station (STA). The operations can configure the processing circuitry to decode a signal received from an access point (AP) at a low-power wake-up radio (LP-WUR) of the STA, the signal including a timing synchronization function (TSF) value, the TSF value including a subset of octets of a TSF timer associated with the AP; synchronize a local TSF timer with the TSF timer associated with the AP by adjusting a local TSF timer according to an amount of time to receive the TSF value and to pass the TSF value to medium access control layer (MAC) layer circuitry of the STA and further based on a count of a number of octets included in the subset of octets; and instruct the LP-WUR to wake up a wireless local area network (WLAN) radio of the STA at a wake-up time based on the local TSF timer.

In Example 16, the subject matter of Example 15 can optionally include wherein the TSF value comprises two least significant octets of the TSF timer associated with the AP.

In Example 17, the subject matter of Example 15 can optionally include wherein the TSF value comprises a three least significant octets of the TSF timer associated with the AP.

In Example 18, a method implemented by a station (STA) can include decoding a signal received from an access point (AP), the signal including a timing synchronization function (TSF) value, the TSF value including a subset of octets of a TSF timer associated with the AP; synchronizing a local TSF timer with the TSF timer associated with the AP by adjusting a local TSF timer according to an amount of time to receive the TSF value and to pass the TSF value to medium access control layer (MAC) layer circuitry of the STA and further based on a count of a number of octets included in the subset of octets; and waking up a wireless local area network (WLAN) radio of the STA at a wake-up time based on the local TSF timer.

In Example 19, the subject matter of Example 18 can optionally include wherein the TSF value comprises two least significant octets of the TSF timer associated with the AP.

In Example 20, the subject matter of Example 18 can optionally include wherein the TSF value comprises three least significant octets of the TSF timer associated with the AP.

In Example 21, the subject matter of Example 18 can optionally include wherein the waking up is performed periodically according to a periodicity based on the count of the number of octets included in the subset of octets of the TSF timer.

In Example 22, the subject matter of Example 18 can optionally include wherein the waking up is performed periodically according to a periodicity that has been set according to an agreement with the AP.

In Example 23, the subject matter of Example 22 can optionally include wherein the waking up is performed periodically based on a target beacon transmission time (TBTT) of the AP.

In Example 24, the subject matter of Example 18 can optionally include wherein the waking up is performed responsive to a failure to receive communications from the AP within a time period.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of a station (STA), the apparatus comprising:
a low-power wake-up radio (LP-WUR); and
processing circuitry to:
decode a signal received from an access point (AP) at the LP-WUR, the signal including a timing synchronization function (TSF) value, the TSF value including a subset of octets of a TSF timer associated with the AP; and
synchronize a local TSF timer with the TSF timer by adjusting the local TSF timer according to an amount of time to receive the TSF value and to pass the TSF value to medium access control layer (MAC) layer circuitry of the STA and further based on a count of a number of octets included in the subset of octets; and
wherein the LP-WUR is configured to wake up a wireless local area network (WLAN) radio of the STA at a wake-up time based on the local TSF timer.

2. The apparatus of claim 1, wherein the TSF value comprises two least significant octets of the TSF timer associated with the AP.

3. The apparatus of claim 1, wherein the TSF value comprises three least significant octets of the TSF timer associated with the AP.

4. The apparatus of claim 1, wherein the LP-WUR is configured to wake up the WLAN radio periodically.

5. The apparatus of claim 4, wherein the LP-WUR is configured to wake up the WLAN radio periodically according to a periodicity based on the count of the number of octets included in the subset of octets of the TSF timer.

6. The apparatus of claim 4, wherein the LP-WUR is configured to wake up the WLAN radio periodically according to a periodicity that has been set according to an agreement with the AP.

7. The apparatus of claim 4, wherein the LP-WUR is configured to wake up the WLAN radio periodically based on a target beacon transmission time (TBTT) of the AP.

8. The apparatus of claim 1, wherein the LP-WUR is configured to wake up the WLAN radio responsive to a failure to receive the signal including the TSF value within a time period.

9. The apparatus of claim 1, wherein the LP-WUR is configured to wake up the WLAN radio responsive to a failure to receive communications from the AP within a time period.

10. The apparatus of claim 1, wherein the processing circuitry is configured to encode a signal for transmission to the AP to notify the AP that the LP-WUR has woken up the WLAN radio.

11. The apparatus of claim 1, wherein the processing circuitry is configured to wake up the LP-WUR periodically.

12. An apparatus of an access point (AP), the apparatus comprising:
processing circuitry to:
encode a signal for transmission to a station (STA) within a basic service set (BSS) served by the AP, the signal including a timing synchronization function (TSF) value, the TSF value including a subset of octets of a TSF timer associated with the AP, the subset including fewer than four octets;
encode a wake-up packet for transmission to the STA subsequent to transmission of the signal; and
decode an acknowledgment from the STA, subsequent to transmission of the wake-up packet, that a low-power wake-up radio (LP-WUR) of the STA has woken a wireless local area network (WLAN) radio of the STA.

13. The apparatus of claim 12, wherein the TSF value includes a two least-significant octets of the TSF timer associated with the AP.

14. The apparatus of claim 12, wherein the TSF value includes a three least-significant octets of the TSF timer associated with the AP.

15. A non-transitory machine-readable medium storing instructions for execution by processing circuitry of a station (STA), the instructions causing the processing circuitry to:
decode a signal received from an access point (AP) at a low-power wake-up radio (LP-WUR) of the STA, the signal including a timing synchronization function (TSF) value, the TSF value including a subset of octets of a TSF timer associated with the AP;
synchronize a local TSF timer with the TSF timer associated with the AP by adjusting a local TSF timer according to an amount of time to receive the TSF value and to pass the TSF value to medium access control layer (MAC) layer circuitry of the STA and further based on a count of a number of octets included in the subset of octets; and
instruct the LP-WUR to wake up a wireless local area network (WLAN) radio of the STA at a wake-up time based on the local TSF timer.

16. The non-transitory machine-readable medium of claim 15, wherein the TSF value comprises two least significant octets of the TSF timer associated with the AP.

17. The non-transitory machine-readable medium of claim 15, wherein the TSF value comprises a three least significant octets of the TSF timer associated with the AP.

18. A method, implemented at a station (STA), the method comprising:
decoding a signal received from an access point (AP), the signal including a timing synchronization function (TSF) value, the TSF value including a subset of octets of a TSF timer associated with the AP;
synchronizing a local TSF timer with the TSF timer associated with the AP by adjusting a local TSF timer according to an amount of time to receive the TSF value and to pass the TSF value to medium access control layer (MAC) layer circuitry of the STA and further based on a count of a number of octets included in the subset of octets; and
waking up a wireless local area network (WLAN) radio of the STA at a wake-up time based on the local TSF timer.

19. The method of claim 18, wherein the TSF value comprises two least significant octets of the TSF timer associated with the AP.

20. The method of claim 18, wherein the TSF value comprises three least significant octets of the TSF timer associated with the AP.

21. The method of claim 18, wherein the waking up is performed periodically according to a periodicity based on the count of the number of octets included in the subset of octets of the TSF timer.

22. The method of claim 18, wherein the waking up is performed periodically according to a periodicity that has been set according to an agreement with the AP.

23. The method of claim 22, wherein the waking up is performed periodically based on a target beacon transmission time (TBTT) of the AP.

24. The method of claim 18, wherein the waking up is performed responsive to a failure to receive communications from the AP within a time period.
